(19) United States
(12) Patent Application Publication
(10) Pub. No.: US 2026/0370146 A1
(43) Pub. Date: Nov. 19, 2026

(54) FLYBACK POWER CONVERSION CIRCUIT FOR GENERATING MULTIPLE OUTPUT VOLTAGES USING AT LEAST ONE TRANSFORMER AND CONTROL METHOD THEREOF

(71) Applicant: Richtek Technology Corporation, Zhubei City (TW)

(72) Inventors: Kuo-Chi LIU, Hsinchu City (TW); Shui-Mu LIN, Taichung City (TW); Shao-Chun HUANG, New Taipei City (TW)

(21) Appl. No.: 19/464,922

(22) Filed: Jan. 30, 2026

Related U.S. Application Data
(60) Provisional application No. 63/806,804, filed on May 16, 2025.

(30) Foreign Application Priority Data
Sep. 25, 2025 (TW) 114136904

(51) Int. Cl. H02M 3/335; H02M 1/00; H02M 1/44

(52) U.S. Cl. CPC H02M 3/33561; H02M 1/0009; H02M 1/44; H02M 3/33592

(57) ABSTRACT

A power conversion circuit includes a first transformer, a second transformer, a first switch, a second switch, an extended switch, and a control circuit. The first transformer includes a first primary coil and a first secondary coil generating a first secondary current. The second transformer includes a second primary coil and a second secondary coil generating a second secondary current. The first switch is coupled between the first secondary coil and a first output voltage. The second switch is coupled between the second secondary coil and the second output voltage. The extended switch is coupled between the first switch and the second switch. The control circuit magnetizes the first transformer and the second transformer in a time-division manner.

### CROSS REFERENCE TO RELATED APPLICATIONS

This application claims the benefit of U.S. Provisional Application No. 63/806,804, filed on May 16, 2025, the entirety of which is incorporated by reference herein.

This Application claims priority of Taiwan Patent Application No. 114136904, filed on Sep. 25, 2025, the entirety of which is incorporated by reference herein.

### BACKGROUND OF THE INVENTION

### Field of the Invention

The disclosure is generally related to a power conversion circuit for generating multiple output voltages and a control method thereof, and more particularly it is related to a flyback power conversion circuit for generating multiple output voltages using at least one transformer and a control method thereof.

### Description of the Related Art

Multi-output power conversion circuits are required in many devices, such as mobile phones, power banks, laptops, digital cameras, tablets, speakers, game consoles, portable computing devices, and wearable devices. Traditional multi-output flyback power conversion circuits require multiple coils on the secondary side and additional independent voltage regulator circuits to regulate the individual output voltages. This can significantly increase the component costs and circuit complexity. To reduce costs and circuit complexity, it is necessary to optimize multi-output power conversion circuits.

### BRIEF SUMMARY OF THE INVENTION

This invention proposes a power conversion circuit for generating multiple output voltages and a control method thereof, which can power multiple output voltages using a single transformer or multiple transformers. When multiple transformers power multiple output voltages, both multiple transformers can power a single output voltage, allowing the power of different transformers to be shared, thereby reducing the required size of the transformers and lowering the maximum current of the input voltage. Furthermore, the multiple transformers in the power conversion circuit proposed in this invention can also individually power different output voltages, enabling the power conversion circuit to generate different output voltages without the assistance of other voltage regulators. In addition, staggering the magnetization periods of multiple transformers can effectively avoid the problem of beat frequency and suppress electromagnetic interference.

In an embodiment, a power conversion circuit is provided, which comprises a first transformer, a first primary switch, a second transformer, a second primary switch, a first switch, a second switch, an extension switch, and a control circuit. The first transformer comprises a first primary coil and a first secondary coil, where the first primary coil receives an input voltage and the first secondary coil generates a first secondary current. The first primary switch couples the first primary coil to a ground based on a first primary control signal. The second transformer comprises a second primary coil and a second secondary coil, wherein the second secondary coil receives the input voltage, and the second secondary coil generates a second secondary current. The second primary switch couples the second primary coil to the ground based on a second primary control signal. The first switch is coupled between the first primary coil and a first output voltage. The second switch is coupled between the second secondary coil and a second output voltage. The extension switch is coupled between the first switch and the second switch. The control circuit drives the first primary switch and the second primary switch to respectively magnetize the first transformer and the second transformer and operates in a first mode and a second mode. When the control circuit operates in the first mode, the first switch and the extension switch are both turned on and the second switch is turned off, so that the first secondary current and the second secondary current both power the first output voltage. When the control circuit operates in the second mode, the first switch and the second switch are both turned on and the extension switch is turned off, so that the first secondary current and the second secondary current power the first output voltage and the second output voltage respectively. The control circuit turns on the first primary switch and the second primary switch in a time-division manner at a switching frequency.

According to an embodiment of the present invention, the switching frequency is adjustable. There is a phase difference between the first primary switch turning on and the second primary switch turning on. The control circuit adjusts the phase difference, causing an on-time of the first primary switch and the second primary switch to be staggered.

According to an embodiment of the present invention, the power conversion circuit further comprises a first synchronous rectification unit and a second synchronous rectification unit. The first synchronous rectification unit is coupled between the first secondary coil and the first switch, causing the first secondary current to flow unidirectionally to the first switch and the extension switch. The second synchronous rectification unit is coupled between the second secondary coil and the second switch, causing the second secondary current to flow unidirectionally to the second switch and the extension switch.

According to an embodiment of the present invention, when the control circuit operates in the first mode, the first switch and the extension switch are turned on and the second switch is turned off, causing both the first secondary current and the second secondary current to power the first output voltage.

According to an embodiment of the present invention, when the control circuit operates in the second mode, the first switch and the second switch are turned on and the extension switch is turned off, causing the first secondary current to independently power the first output voltage and the second secondary current to independently power the second output voltage.

According to an embodiment of the present invention, when the control circuit operates in a third mode, the second switch and the extension switch are turned on and the first switch is turned off, causing both the first secondary current and the second secondary current to power the second output voltage.

According to an embodiment of the present invention, the control circuit further comprises a first error amplifier, a second error amplifier, a first multiplexer, a second multiplexer, a first isolation circuit, a second isolation circuit, a first signal generation circuit, and a second signal generation circuit. The first error amplifier compares the first output voltage to a first reference voltage to generate a first error signal. The second error amplifier compares the second output voltage to a second reference voltage to generate a second error signal. The first multiplexer outputs the first error signal or the second error signal as a first selection signal based on the states of the first switch, the second switch, and the extension switch. The second multiplexer outputs the first error signal or the second error signal as a second selection signal based on the states of the first switch, the second switch, and the extension switch. The first isolation circuit generates a first feedback signal based on the first selection signal. The second isolation circuit generates a second feedback signal based on the second selection signal. The first signal generation circuit drives the first primary switch based on the first feedback signal. The second signal generation circuit drives the second primary switch based on the second feedback signal.

According to an embodiment of the present invention, when the control circuit operates in the first mode, the first signal generation circuit and the second signal generation circuit extend an on-time of the first primary switch and an on-time of the second primary switch based on the first output voltage that is lower than the first reference voltage. When the control circuit operates in the first mode, the first signal generation circuit and the second signal generation circuit shorten the on-time of the first primary switch and the on-time of the second primary switch based on the first output voltage that is lower than the first reference voltage.

According to an embodiment of the present invention, when the control circuit operates in the second mode, the first signal generation circuit turns on the first primary switch based on the first output voltage that is lower than the first reference voltage, and the second signal generation circuit turns on the second primary switch based on the second output voltage that is lower than the second reference voltage. When the control circuit operates in the second mode, the first signal generation circuit shortens an on-time of the first primary switch based on the first output voltage that is not lower than the first reference voltage, and the second signal generation circuit shortens an on-time of the second primary switch based on the second output voltage that is not lower than the second reference voltage. When the control circuit operates in the second mode, the first signal generation circuit extends the on-time of the first primary switch based on the first output voltage that is lower than the first reference voltage, and the second signal generation circuit extends the on-time of the second primary switch based on the second output voltage that is lower than the second reference voltage.

According to an embodiment of the present invention, when the control circuit operates in the third mode, the first signal generation circuit and the second signal generation circuit extend an on-time of the first primary switch and an on-time of the second primary switch based on the second output voltage that is lower than the second reference voltage. When the control circuit operates in the third mode, the first signal generation circuit and the second signal generation circuit shorten the on-time of the first primary switch and the on-time of the second primary switch based on the second output voltage that is not lower than the second reference voltage.

According to an embodiment of the present invention, the power conversion circuit further comprises a third switch. The third switch is coupled between the first secondary coil and a third output voltage. When the third switch is turned on, the first secondary current powers the third output voltage.

According to an embodiment of the present invention, the power conversion circuit further comprises a fourth switch. The fourth switch is coupled between the second secondary coil and a fourth output voltage. When the fourth switch is turned on, the second secondary current powers the fourth output voltage.

According to an embodiment of the present invention, the power conversion circuit further comprises an additional extension switch. The additional extension switch is coupled between the third switch and the fourth switch.

In another embodiment, a control method for controlling a power conversion circuit to convert an input voltage into a first output voltage and a second output voltage is provided. The power conversion circuit comprises a first transformer and a second transformer. The control method comprises the following steps. The first transformer is magnetized using the input voltage during a first magnetization period. When the first transformer is demagnetized, either the first output voltage or the second output voltage is powered using a first secondary current generated by a secondary coil of the first transformer. The second transformer is magnetized using the input voltage during a second magnetization period. When the second transformer is demagnetized, either the first output voltage or the second output voltage is powered using a second secondary current generated by a secondary coil of the second transformer.

According to an embodiment of the present invention, the control method further comprises the following steps. It is determined that the power conversion circuit operates in one of a first mode, a second mode, and a third mode. When operating in the first mode, the first output voltage is powered using the first secondary current and the second secondary current. When operating in the second mode, the first output voltage is powered using the first secondary current, and the second output voltage is powered using the second secondary current using the second secondary current. When operating in the third mode, the second output voltage is powered using the first secondary current and the second secondary current.

According to an embodiment of the present invention, the control method further comprises the following steps. When operating in the first mode, a relationship between the first output voltage and a first reference voltage is determined. When the first output voltage is lower than the first reference voltage, the first magnetization period and the second magnetization period are extended based on a difference between the first output voltage and the first reference voltage. When the first output voltage is not lower than the first reference voltage, the first magnetization period and the second magnetization period are shortened based on the difference between the first output voltage and the first reference voltage.

According to an embodiment of the present invention, the control method further comprises the following steps. When operating in the second mode, a relationship between the first output voltage and a first reference voltage and a relationship between the second output voltage and a second reference voltage are determined. When the first output voltage is lower than the first reference voltage, the first magnetization period is extended based on a difference between the first output voltage and the first reference voltage. When the first output voltage is not lower than the first reference voltage, the first magnetization period is shortened based on the first output voltage and the first reference voltage. When the second output voltage is lower than the second reference voltage, the second magnetization period is extended based on a difference between the second output voltage and the second reference voltage. When the second output voltage is not lower than the second reference voltage, the second magnetization period is shortened based on the difference between the second output voltage and the second reference voltage.

According to an embodiment of the present invention, the control method further comprises the following steps. When operating in the third mode, a relationship between the second output voltage and a second reference voltage is determined. When the second output voltage is lower than the second reference voltage, the first magnetization period and the second magnetization period are extended based on a difference between the second output voltage and the second reference voltage. When the second output voltage is not lower than the second reference voltage, the first magnetization period and the second magnetization period are shortened based on the difference between the second output voltage and the second reference voltage.

According to an embodiment of the present invention, the control method further comprises the following steps. There is an interval period between the first magnetization period and the second magnetization period. The interval period is not less than zero.

According to an embodiment of the present invention, the control method further comprises the following steps. When a first primary current flowing through a first primary coil of the first transformer is not less than a first threshold, the first magnetization period is ended. When a second primary current flowing through a second primary coil of the second transformer is not less than a second threshold, the second magnetization period is ended.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a schematic diagram of a power conversion circuit in accordance with an embodiment of the present invention;

FIG. 2 shows a schematic diagram of a power conversion circuit in accordance with another embodiment of the present invention;

FIG. 3 shows a schematic diagram of a power conversion circuit in accordance with yet another embodiment of the present invention;

FIG. 4 shows a waveform diagram of a power conversion circuit in accordance with an embodiment of the present invention;

FIG. 5 shows a schematic diagram of a power conversion circuit in accordance with yet another embodiment of the present invention;

FIG. 6 shows a waveform diagram of a power conversion circuit in accordance with another embodiment of the present invention;

FIG. 7 shows a schematic diagram of a power conversion circuit in accordance with yet another embodiment of the present invention;

FIG. 8 shows a waveform diagram of a power conversion circuit in accordance with an embodiment of the present invention;

FIG. 9 shows a schematic diagram of the control circuit in accordance with another embodiment of the present invention;

FIG. 10 shows a schematic diagram of the power conversion circuit in accordance with another embodiment of the present invention;

FIG. 11 shows a schematic diagram of the power conversion circuit in accordance with another embodiment of the present invention;

FIG. 12 shows a schematic diagram of the control circuit in accordance with yet another embodiment of the present invention;

FIG. 13 shows a schematic diagram of the control circuit in accordance with yet another embodiment of the present invention;

FIG. 14 shows a schematic diagram of the power conversion circuit in accordance with yet another embodiment of the present invention; and

FIG. 15 shows a flowchart of the control method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

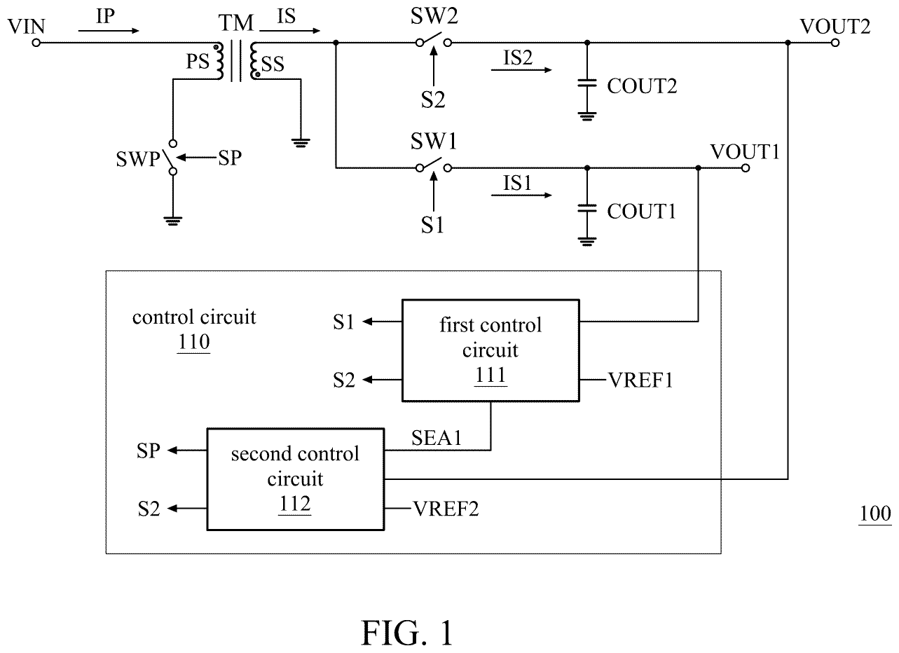

FIG. 1 shows a schematic diagram of a power conversion circuit in accordance with an embodiment of the present invention. As shown in FIG. 1, the power conversion circuit 100 includes a transformer TM, a primary switch SWP, a first switch SW1, a first output capacitor COUT1, a second switch SW2, a second output capacitor COUT2, and a control circuit 110.

The transformer TM includes a primary coil PS and a secondary coil SS. One terminal of the primary coil PS receives an input voltage VIN. The primary switch SWP is coupled between the other terminal of the primary coil PS and a ground. According to an embodiment of the present invention, when the primary switch SWP is turned on, the primary coil PS (i.e., the transformer TM) is magnetized, causing the primary current IP to increase. According to another embodiment of the present invention, when the primary switch SWP is turned off, the primary coil PS (i.e., the transformer TM) is demagnetized, causing the secondary coil SS to generate a secondary current IS. In an embodiment, the transformer TM has only a single secondary coil SS and no other secondary coil. In other words, the transformer TM has only one secondary coil SS.

When the transformer TM is demagnetized, the first switch SW1 and the second switch SW2 are turned on in a time-sharing manner, causing the secondary current IS to generate a first supply current IS1 and a second supply current IS2 at different times. These currents are configured to charge the first output capacitor COUT1 and the second output capacitor COUT2, respectively, thereby generating a first output voltage VOUT1 and a second output voltage VOUT2. The control circuit 110 generates a first signal S1 based on the first output voltage VOUT1, a second signal S2 based on the second output voltage VOUT2, and a primary control signal SP based on both the first and second output voltages VOUT1 and VOUT2, thereby controlling the first switch SW1, the second switch SW2, and the primary switch SWP, respectively.

As shown in FIG. 1, the control circuit 110 includes a first control circuit 111 and a second control circuit 112. The first control circuit 111 generates the first signal S1 and the second signal S2 based on the first output voltage VOUT1, and generates a first error signal SEA1 based on the difference between the first output voltage VOUT1 and the first reference voltage VREF1. The second control circuit 112 generates a primary control signal SP based on the first error signal SEA1, the second output voltage VOUT2, and the second reference voltage VREF2, and generates a second signal S2 based on the second output voltage VOUT2.

According to some embodiments of the present invention, the first control circuit 111 determines the on-time of the first switch SW1 based on the first output voltage VOUT1, the second control circuit 112 determines the on-time of the second switch SW2 based on the second output voltage VOUT2, and the second control circuit 112 further determines the on-time of the primary switch SWP based on the difference between the first output voltage VOUT1 and the first reference voltage VREF1 and the difference between the second output voltage VOUT2 and the second reference voltage VREF2.

According to an embodiment of the present invention, the power conversion circuit 100 may be a flyback power conversion circuit. For the sake of simplicity, the description herein refers to the power conversion circuit 100 generating the first output voltage VOUT1 and the second output voltage VOUT2, and is not intended to be limited thereto. According to other embodiments of the present invention, the power conversion circuit 100 may also generate any number of output voltages.

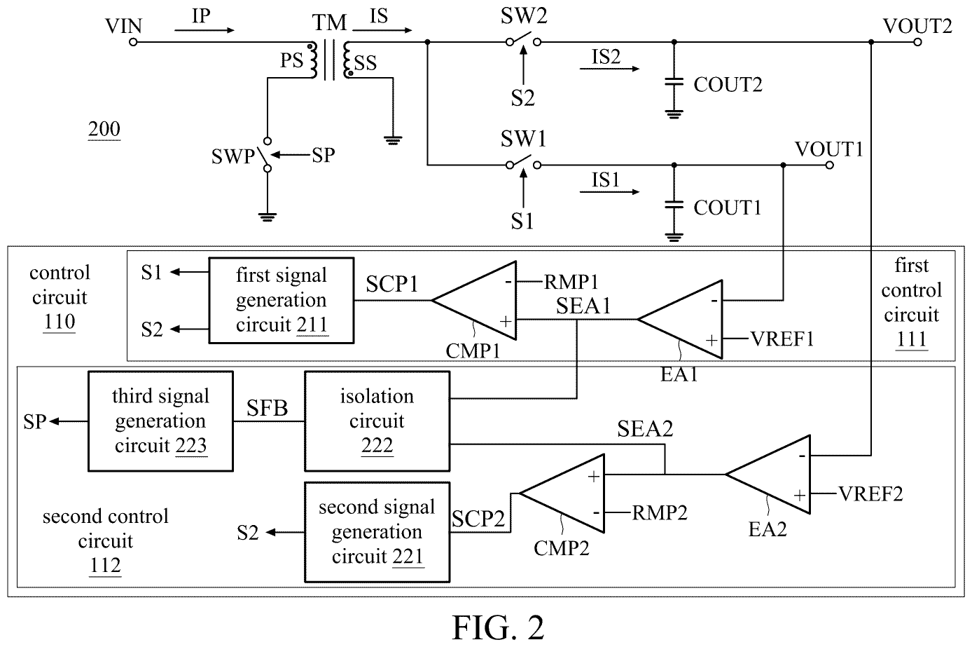

FIG. 2 shows a schematic diagram of a power conversion circuit in accordance with another embodiment of the present invention. Compared with the power conversion circuit 100 of FIG. 1, the first control circuit 111 of the power conversion circuit 200 includes a first error amplifier EA1, a first comparator CMP1, and a first signal generation circuit 211.

The first error amplifier EA1 generates a first error signal SEA1 based on the difference between the first output voltage VOUT1 and the first reference voltage VREF1. According to an embodiment of the present invention, when the first output voltage VOUT1 decreases, the first error signal SEA1 increases. According to another embodiment of the present invention, when the first output voltage VOUT1 increases, the first error signal SEA1 decreases.

In other words, the first error amplifier EA1 amplifies the difference between the first output voltage VOUT1 and the first reference voltage VREF1 to generate the first error signal SEA1. A first comparator CMP1 compares a first error signal SEA1 with a first sawtooth wave RMP1 to generate a first comparison signal SCP1. A first signal generation circuit 211 generates a first signal S1 and a second signal S2 based on the first comparison signal SCP1.

As shown in FIG. 2, the second control circuit 112 includes a second error amplifier EA2, a second comparator CMP2, a second signal generation circuit 221, an isolation circuit 222, and a third signal generation circuit 223. The second error amplifier EA2 generates a second error signal SEA2 based on the difference between a second output voltage VOUT2 and a second reference voltage VREF2.

The second error amplifier EA2 generates the second error signal SEA2 based on the second output voltage VOUT2 and the second reference voltage VREF2. According to an embodiment of the present invention, when the second output voltage VOUT2 decreases, the second error signal SEA2 increases. According to another embodiment of the present invention, when the second output voltage VOUT2 increases, the second error signal SEA2 decreases.

In other words, the second error amplifier EA2 amplifies the difference between the second output voltage VOUT2 and the second reference voltage VREF2 to generate a second error signal SEA2. The second comparator CMP2 compares the second error signal SEA2 with the second sawtooth wave RMP2 to generate a second comparison signal SCP2. The second signal generation circuit 221 generates a second signal S2 based on the second comparison signal SCP2.

The isolation circuit 222 generates a feedback signal SFB based on the first error signal SEA1 and the second error signal SEA2. According to an embodiment of the present invention, the isolation circuit 222 may be an optocoupler. According to another embodiment of the present invention, the isolation circuit 222 may be an isolation transformer, where the isolation transformer includes an inductive transformer and a capacitive transformer.

The third signal generation circuit 223 generates a primary control signal SP based on the feedback signal SFB. In other words, the isolation circuit 222 and the third signal generation circuit 223 adjust the on-time of the primary switch SWP based on the difference between the first output voltage VOUT1 and the first reference voltage VREF1 and the difference between the second output voltage VOUT2 and the second reference voltage VREF2, thereby changing the magnetization period.

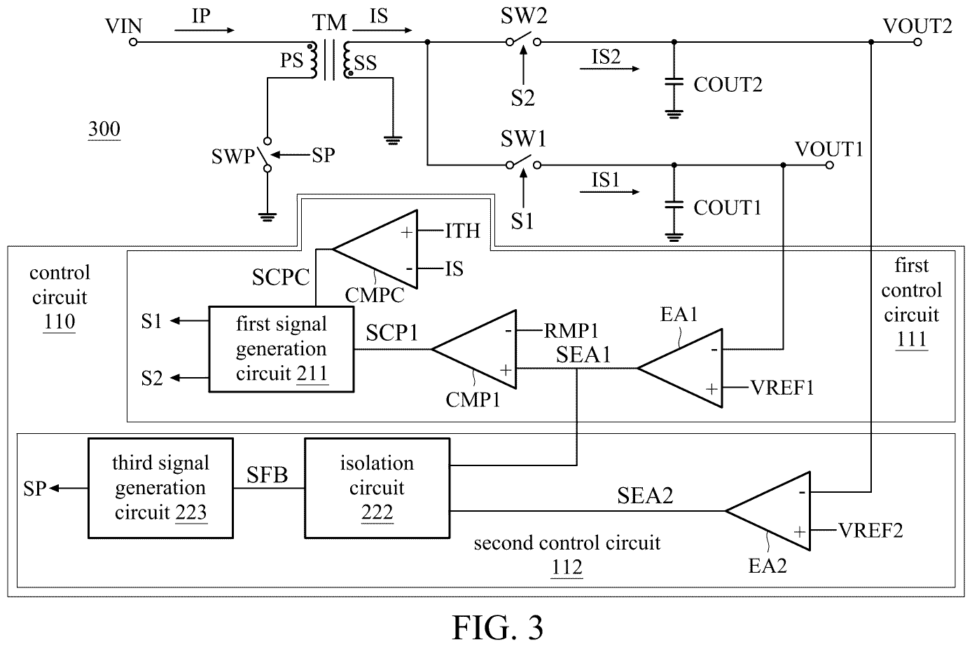

FIG. 3 shows a schematic diagram of a power conversion circuit in accordance with yet another embodiment of the present invention. Compared with the power conversion circuit 200 of FIG. 2, the power conversion circuit 300 uses a current comparator CMPC to replace the second comparator CMP2 and the second signal generation circuit 221 in FIG. 2.

As shown in FIG. 3, the current comparator CMPC compares the secondary current IS with the current threshold ITH to generate a current comparison signal SCPC. According to an embodiment of the present invention, when the secondary current IS is less than the current threshold ITH, the current comparator CMPC enables the current comparison signal SCPC. According to another embodiment of the present invention, when the secondary current IS is not less than the current threshold ITH, the current comparator CMPC disables the current comparison signal SCPC.

According to some embodiments of the present invention, after the first signal generation circuit 211 enables the second signal S2 and the secondary current IS is less than the current threshold ITH, the first signal generation circuit 211 disables the second signal S2 based on the enabled current comparison signal SCPC, thereby turning off the second switch SW2. In other words, when the secondary current IS drops to near zero, the control circuit 110 turns off the second switch SW2, thereby stopping the supply of power at the second output voltage VOUT2, where the current threshold ITH is close to zero. According to some embodiments of the present invention, when the transformer TM finishes demagnetization, the control circuit 110 immediately turns off the second switch SW2.

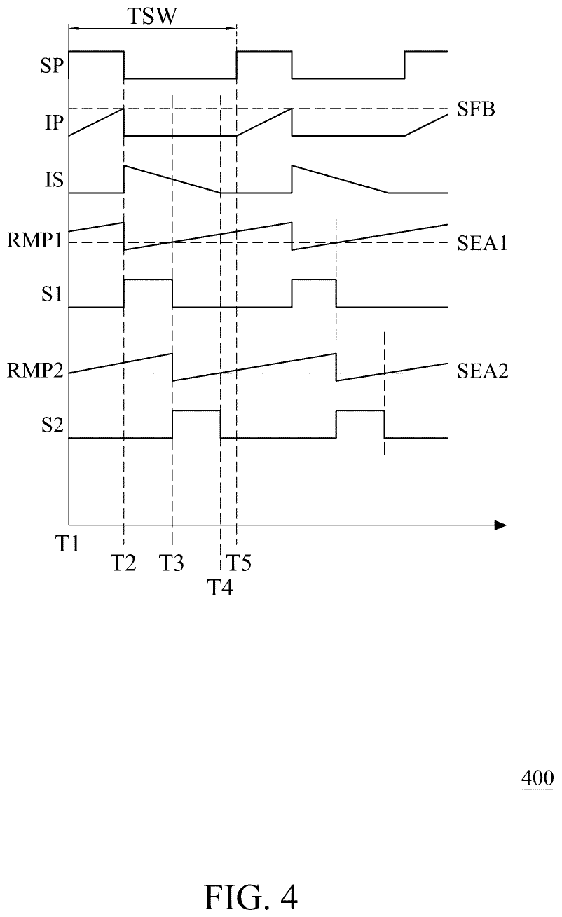

FIG. 4 shows a waveform diagram of a power conversion circuit in accordance with an embodiment of the present invention. The following description of the waveform 400 will be accompanied by the power conversion circuit 200 in FIG. 2 and the power conversion circuit 300 in FIG. 3 for detailed explanation.

As shown in FIG. 4, at the first time point T1, the primary control signal SP is enabled to turn on the primary switch SWP, magnetizing the transformer TM. Between the first time point T1 and the second time point T2, the primary current IP increases linearly. At the second time point T2, the primary control signal SP is disabled to turn off the primary switch SWP, demagnetizing the transformer TM to generate a secondary current IS.

When the transformer TM begins to demagnetize at the second time point T2 to generate a secondary current IS, the first signal generation circuit 211 enables the first signal S1 to turn on the first switch SW1, causing the secondary current IS to charge the first output capacitor COUT1 to generate the first output voltage VOUT1.

When the first sawtooth wave RMP1 rises to a level not less than the first error signal SEA1 at the third time point T3, the first signal generation circuit 211 disables the first signal S1 based on the disabled first comparison signal SCP1, thereby turning off the first switch SW1. Furthermore, when the first signal generation circuit 211 disables the first signal S1 at the third time point T3, it simultaneously enables the second signal S2, thereby turning on the second switch SW2.

In other words, when the first sawtooth wave RMP1 is not less than the first error signal SEA1, the first signal generation circuit 211 disables the first signal S1 and enables the second signal S2 based on the disabled first comparison signal SCP1, thereby turning off the first switch SW1 and turning on the second switch SW2, causing the secondary current IS to stop supplying power to the first output voltage VOUT1 and start supplying power to the second output voltage VOUT2 at the third time point T3.

When the second sawtooth wave RMP2 rises to not less than the second error signal SEA2 at the fourth time point T4, the second signal generation circuit 221 disables the second signal S2 based on the disabled second comparison signal SCP2, thereby turning off the second switch SW2. According to some embodiments of the present invention, the control circuit 110 determines the on-time of the first switch SW1 based on the first output voltage VOUT1, and determines the on-time of the second switch SW2 based on the second output voltage VOUT2.

According to other embodiments of the present invention, since the secondary current IS drops to zero at the fourth time point T4, the first signal generation circuit 211 can disable the second signal S2 based on the secondary current IS dropping to zero (or the secondary current IS dropping below a threshold), thereby turning off the second switch SW2. In other words, in the embodiment of FIG. 3, the control circuit 110 determines the on-time of the first switch SW1 based on the first output voltage VOUT1, and determines the on-time of the second switch SW2 based on the secondary current IS.

At the fifth time point T5, the isolation circuit 222 and the third signal generation circuit 223 enable the primary control signal SP based on the first error signal SEA1 and the second error signal SEA2, thereby turning on the primary switch SWP. As shown in FIG. 4, the period from the first time point T1 to the fifth time point T5 constitute the switching time TSW. According to some embodiments of the present invention, the isolation circuit 222 and the third signal generation circuit 223 can control the enable period of the primary control signal SP, thereby adjusting the on-time of the primary switch SWP. According to some embodiments of the present invention, when the third signal generation circuit 223 turns on the primary switch SWP at the fifth time point T5, the isolation circuit 222 and the third signal generation circuit 223 determine the length of the on-time of the primary switch SWP based on the first error signal SEA1 and the second error signal SEA2.

For example, the output power of the first output voltage VOUT1 suddenly increases between the third time point T3 and the fourth time point T4, causing the voltage value of the first output voltage VOUT1 to decrease. The isolation circuit 222 and the third signal generation circuit 223 can determine that the first output voltage VOUT1 requires more energy based on the first error signal SEA1 to extend the on-time of the primary switch SWP, thereby increasing the maximum value of the primary current IP.

According to an embodiment of the present invention, the period from the first time point T1 to the second time point T2 is the magnetization period of the transformer TM. According to another embodiment of the present invention, the period from the second time point T2 to the fourth time point T4 is the demagnetization period of the transformer TM.

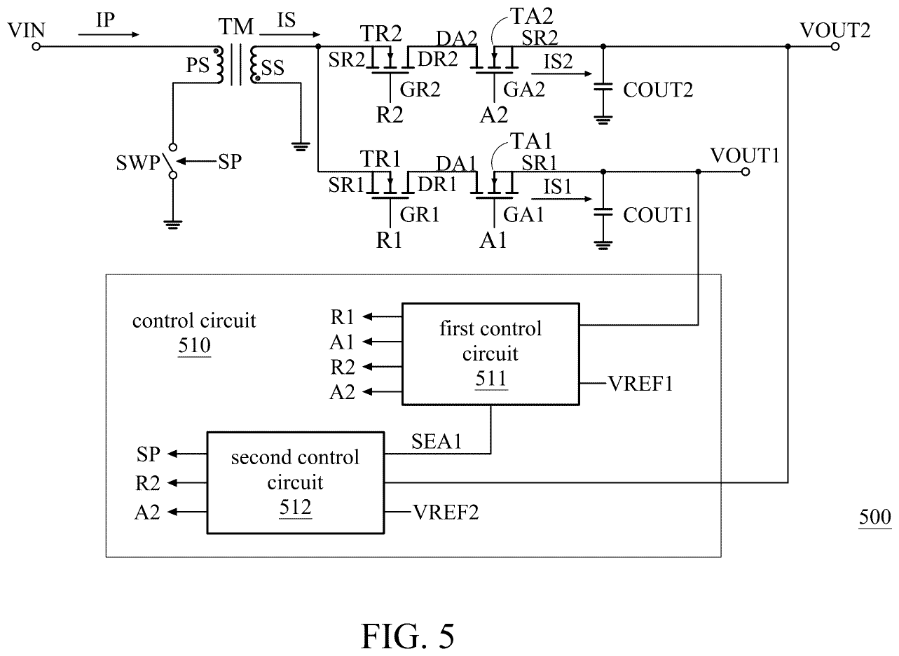

FIG. 5 shows a schematic diagram of a power conversion circuit in accordance with yet another embodiment of the present invention. Comparing the power conversion circuit 500 with the power conversion circuit 100 of FIG. 1, the first switch SW1 in FIG. 1 is replaced by a first rectification transistor TR1 and a first blocking transistor TA1, and the second switch SW2 in FIG. 1 is replaced by a second rectification transistor TR2 and a second blocking transistor TA2. Furthermore, the control circuit 110 in FIG. 1 is replaced by a control circuit 510.

The first rectification transistor TR1 includes a first rectification gate terminal GR1, a first rectification drain terminal DR1, and a first rectification source terminal SR1. The first blocking transistor TA1 includes a first blocking gate terminal GA1, a first blocking drain terminal DA1, and a first blocking source terminal SA1. The first rectification gate terminal GR1 receives the first rectification signal R1. The first rectification drain terminal DR1 is electrically connected to the first blocking drain terminal DA1. The first rectification source terminal SR1 receives the secondary current IS. The first blocking gate terminal GA1 receives the first blocking signal A1. The first blocking source terminal SA1 is coupled to the first output voltage VOUT1.

The second rectification transistor TR2 includes a second rectification gate terminal GR2, a second rectification drain terminal DR2, and a second rectification source terminal SR2. The second blocking transistor TA2 includes a second blocking gate terminal GA2, a second blocking drain terminal DA2, and a second blocking source terminal SA2. The second rectification gate terminal GR2 receives the second rectification signal R2. The second rectification drain terminal DR2 is electrically connected to the second blocking drain terminal DA2. The second rectification source terminal SR2 receives the secondary current IS. The second blocking gate terminal GA2 receives the second blocking signal A2. The second blocking source terminal SA2 is coupled to the second output voltage VOUT2.

As shown in FIG. 5, the control circuit 510 includes a first control circuit 511 and a second control circuit 512. The first control circuit 511 generates a first rectification signal R1, a first blocking signal A1, a second rectification signal R2, and a second blocking signal A2 based on the first output voltage VOUT1, and generates a first error signal SEA1 based on the difference between the first output voltage VOUT1 and the first reference voltage VREF1. The second control circuit 112 generates a primary control signal SP based on the first error signal SEA1, the second output voltage VOUT2, and the second reference voltage VREF2, and generates a second rectification signal R2 and a second blocking signal A2 based on the second output voltage VOUT2.

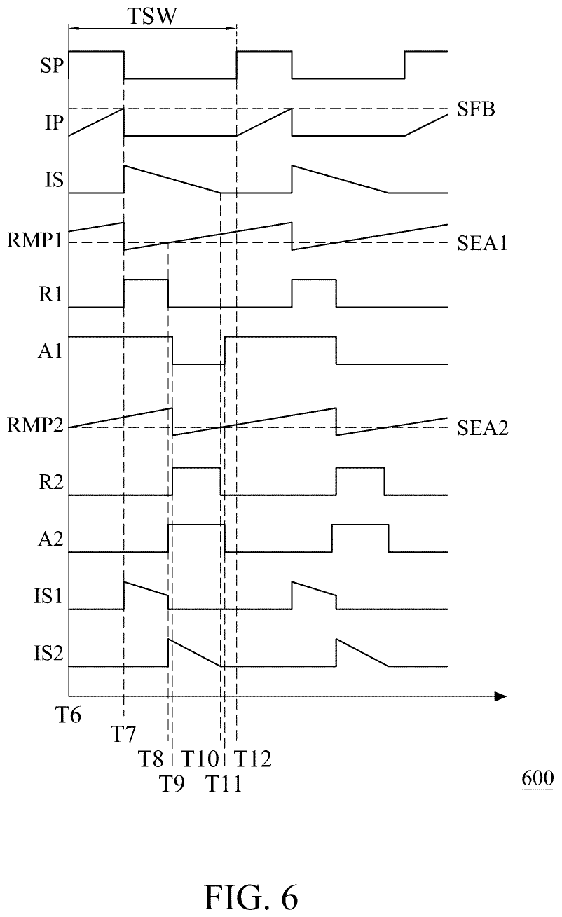

FIG. 6 shows a waveform diagram of a power conversion circuit in accordance with another embodiment of the present invention. The following description of waveform 600 will be provided in conjunction with the power conversion circuit 500 in FIG. 5 for detailed explanation.

As shown in FIG. 6, at the sixth time point T6, the primary control signal SP is enabled, turning on the primary switch SWP, causing the transformer TM to be magnetized. From the sixth time point T6 to the seventh time point T7, the primary current IP increases linearly. At the seventh time point T7, since the primary current IP is not less than the feedback signal SFB, the primary control signal SP is disabled to turn off the primary switch SWP, causing the transformer TM to be demagnetized to generate a secondary current IS.

According to some embodiments of the present invention, the power conversion circuit 500 may include a current detection circuit (not shown in FIG. 5) for detecting the primary current IP to generate a current detection signal. When the current detection signal is not less than the feedback signal SFB, the second control circuit 512 turns off the primary switch SWP at the seventh time point T7. The primary current IP is configured to represent the current detection signal in FIG. 6 for illustration and explanation, but this is not intended to be limited thereto.

When the transformer TM begins demagnetization to generate a secondary current IS at the seventh time point T7, the first rectification signal R1 is simultaneously enabled to turn on the first rectification transistor TR1. Combined with the already turned-on first blocking transistor TA1, this causes the secondary current IS to charge the first output capacitor COUT1 to generate the first output voltage VOUT1. As shown in FIGS. 5 and 6, from time point T7 to time point T8, the secondary current IS flows through the first rectification transistor TR1 and the first blocking transistor TA1 to generate a first supply current IS1 that charges the first output capacitor COUT1.

When the first sawtooth wave RMP1 rises to a level not less than the first error signal SEA1 at time point T8, the first rectification signal R1 is disabled, the first blocking signal A1 remains enabled, and the second blocking signal A2 is enabled, causing the first rectification transistor TR1 to turn off, the first blocking transistor TA1 to remain on, and the second blocking transistor TA2 to turn on.

According to some embodiments of the present invention, since the first rectification transistor TR1 and the second rectification transistor TR2 are turned off and the first blocking transistor TA1 and the second blocking transistor TA2 are turned on between the eighth time point T8 and the ninth time point T9, the secondary current IS supplies power to one of the first output voltage VOUT1 and the second output voltage VOUT2 having the lowest voltage value through the parasitic diode of the first rectification transistor TR1 or the second rectification transistor TR2.

In the embodiment of FIG. 6, the explanation is based on the example that the voltage value of the second output voltage VOUT2 is lower than the voltage value of the first output voltage VOUT1, but it is not intended to be limited thereto. As shown in the embodiment of FIG. 6, since the second output voltage VOUT2 is lower than the first output voltage VOUT1, the second output voltage VOUT2 is powered during the period from the eighth time point T8 to the ninth time point T9. Furthermore, when both the first blocking transistor TA1 and the second blocking transistor TA2 are turned on, the parasitic diode of the first rectification transistor TR1 and the parasitic diode of the second rectification transistor TR2 prevent the first output voltage VOUT1 and the second output voltage VOUT2 from powering the secondary coil SS, and also prevent the first output voltage VOUT1 and the second output voltage VOUT2 from powering each other.

At the ninth time point T9, the second rectification signal R2 is enabled and the first blocking signal A1 is disabled, causing the second rectification transistor TR2 to be turned on and the first blocking transistor TA1 to be turned off. In other words, after the ninth time point T9, the power is supplied to the second output voltage VOUT2. As shown in FIG. 6, between the ninth time point T9 and the tenth time point T10, the secondary current IS flows through the second rectification transistor TR2 and the second blocking transistor TA2 to generate a second supply current IS2 that charges the second output capacitor COUT2.

According to an embodiment of the present invention, at the tenth time point T10, the second sawtooth wave RMP2 rises to a level not less than the second error signal SEA2, causing the second rectification signal R2 to be disabled and the second rectification transistor TR2 to be turned off. According to another embodiment of the present invention, since the secondary current IS drops to zero at the tenth time point T10, the control circuit 510 can disable the second signal S2 based on the secondary current IS dropping to zero (or the secondary current IS dropping below the current threshold), thereby turning off the second switch SW2. At the eleventh time point T11, the first blocking signal A1 is enabled and the second blocking signal A2 is disabled, causing the first blocking transistor TA1 to be turned on and the second blocking transistor TA2 to be turned off.

At the twelfth time point T12, the primary control signal SP is enabled to tur on the primary switch SWP, and the on-time of the primary switch SWP is determined according to the first output voltage VOUT1 and the second output voltage VOUT2. According to some embodiments of the present invention, the period from the sixth time point T6 to the twelfth time point T12 is the switching period TSW.

By replacing the first switch SW1 in FIG. 1 with the first rectification transistor TR1 and the first blocking transistor TA1 in FIG. 5 and by replacing the second switch SW2 in FIG. 1 with the second rectification transistor TR2 and the second blocking transistor TA2 in FIG. 5, it prevents that the first output voltage VOUT1 and the second output voltage VOUT2 supply power to each other, and prevents the discharge of the first output voltage VOUT1 and the second output voltage VOUT2 to the ground via the secondary coil SS.

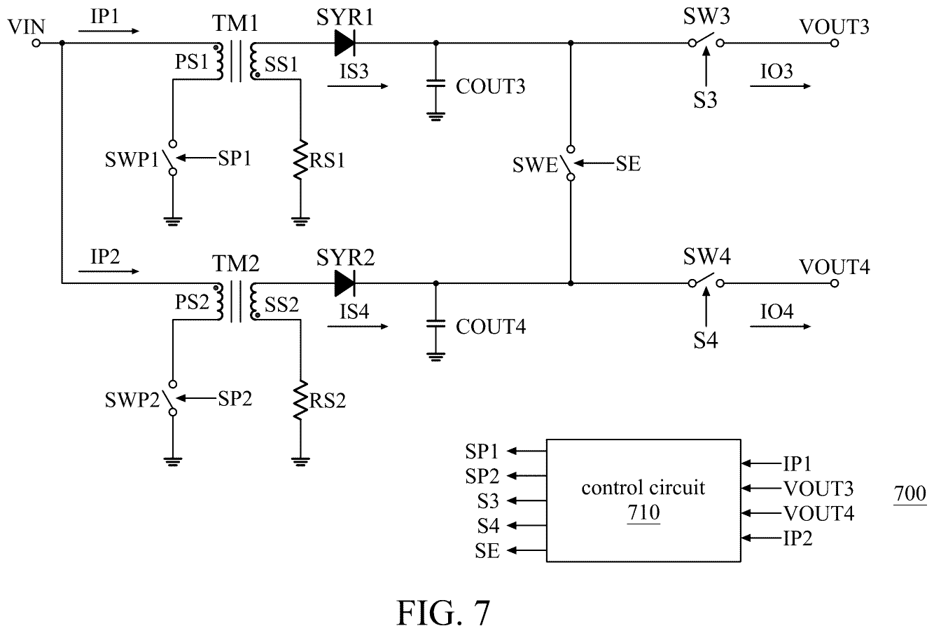

FIG. 7 shows a schematic diagram of a power conversion circuit in accordance with yet another embodiment of the present invention. As shown in FIG. 7, the power conversion circuit 700 includes a first transformer TM1, a first primary switch SWP1, a first sensing resistor RS1, a first synchronous rectification unit SYR1, a third output capacitor COUT3, a second transformer TM2, a second primary switch SWP2, a second sensing resistor RS2, a second synchronous rectification unit SYR2, a fourth output capacitor COUT4, a third switch SW3, a fourth switch SW4, an extension switch SWE, and a control circuit 710.

The first transformer TM1 includes a first primary coil PS1 and a first secondary coil SS1, where the first primary coil PS1 receives an input voltage VIN, and the first primary switch SWP1 is coupled between the first primary coil PS1 and a ground. When the first primary switch SWP1 is turned on based on a first primary control signal SP1, the input voltage VIN magnetizes the first transformer TM1 to generate a first primary current IP1 flowing through the first primary coil PS1.

The first secondary coil SS1 is coupled between the first sensing resistor RS1 and the first synchronous rectification unit SYR1. When the first transformer TM1 is demagnetized, the first sensing resistor RS1 detects the third secondary current IS3 generated by the first secondary coil SS1, and the first synchronous rectification unit SYR1 unidirectionally provides the third secondary current IS3 to the third output capacitor COUT3, thereby charging the third output capacitor COUT3.

The second transformer TM2 includes a second primary coil PS2 and a second secondary coil SS2. The second primary coil PS2 receives the input voltage VIN, and the second primary switch SWP2 is coupled between the second primary coil PS2 and the ground. When the second primary switch SWP2 is turned on based on the second primary control signal SP2, the input voltage VIN magnetizes the second transformer TM2 to generate a second primary current IP2 flowing through the second primary coil PS2.

The second secondary coil SS2 is coupled between the second sensing resistor RS2 and the second synchronous rectification unit SYR2. When the second transformer TM2 is demagnetized, the second sensing resistor RS2 is configured to detect the fourth secondary current IS4 generated by the second secondary coil SS2, and the second synchronous rectification unit SYR2 unidirectionally provides the fourth secondary current IS4 to the fourth output capacitor COUT4, so that the fourth secondary current IS4 charges the fourth output capacitor COUT4.

The third switch SW3 is coupled between the third output capacitor COUT3 and the third output voltage VOUT3, where the third output current IO3 flows through the third switch SW3. The fourth switch SW4 is coupled between the fourth output capacitor COUT4 and the fourth output voltage VOUT4, where the fourth output current IO4 flows through the fourth switch SW4. The extension switch SWE is coupled between the third output capacitor COUT3 and the fourth output capacitor COUT4.

The control circuit 710 operates in one of the first mode, the second mode, and the third mode to generate a third signal S3, a fourth signal S4, and an extended signal SE, thereby controlling the third switch SW3, the fourth switch SW4, and the extended switch SWE. Furthermore, the control circuit 710 generates a first primary control signal SP1 and a second primary control signal SP2 based on the first primary current IP1, the second primary current IP2, the third output voltage VOUT3, and the fourth output voltage VOUT4, and uses the same switching frequency to time-divisionally turn on the first primary switch SWP1 and the second primary switch SWP2. According to some embodiments of the present invention, the switching frequency is adjustable.

According to an embodiment of the present invention, when the control circuit 710 operates in the first mode, the control circuit 710 enables the third signal S3 and the extended signal SE and disables the fourth signal S4 to turn on the third switch SW3 and the extended switch SWE and turn off the fourth switch SW4, so that the third secondary current IS3 and the fourth secondary current IS4 both power the third output voltage VOUT3.

According to another embodiment of the present invention, when the control circuit 710 operates in the second mode, the control circuit 710 enables the third signal S3 and the fourth signal S4 and disables the extended signal SE to turn on the third switch SW3 and the fourth switch SW4 and turn off the extended switch SWE, so that the third secondary current IS3 and the fourth secondary current IS4 power the third output voltage VOUT3 and the fourth output voltage VOUT4, respectively.

According to yet another embodiment of the present invention, when the control circuit 710 operates in the third mode, the control circuit 710 enables the fourth signal S4 and the extended signal SE and disables the third signal S3 to turn on the fourth switch SW4 and the extended switch SWE and turn off the third switch SW3, so that the third secondary current IS3 and the fourth secondary current IS4 both power the fourth output voltage VOUT4.

According to some embodiments of the present invention, when the power conversion circuit 700 powers an external device (not shown in FIG. 7), the external device informs the power conversion circuit 700 of the required power information via a communication interface (not shown in FIG. 7). Based on the power information, the power conversion circuit 700 operates in one of a first mode, a second mode, and a third mode to control the third switch SW3, the fourth switch SW4, and the extension switch SWE. In other words, the power conversion circuit 700 turns the third switch SW3, the fourth switch SW4, and the extension switch SWE on or off based on the request of the external device.

According to other embodiments of the present invention, the power conversion circuit 700 may also include multiple transformers and multiple output voltages, and the multiple transformers may simultaneously power a certain output voltage or individually power different output voltages. In the embodiment of FIG. 7, the power conversion circuit 700 is described as generating two output voltages using two transformers, and is not intended to be limited thereto. According to some embodiments of the present invention, the power conversion circuit 700 may be a flyback power conversion circuit.

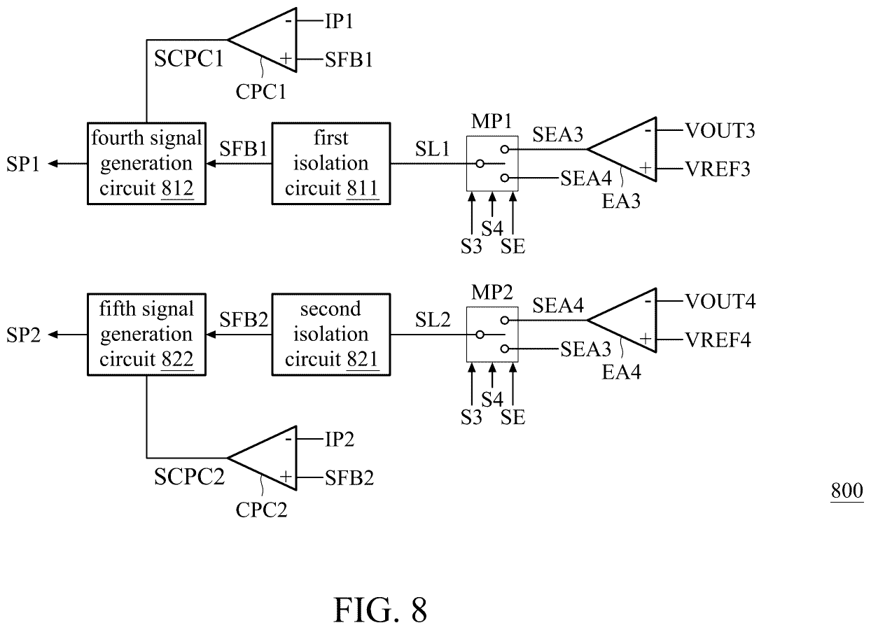

FIG. 8 shows a waveform diagram of a power conversion circuit in accordance with an embodiment of the present invention. According to some embodiments of the present invention, the control circuit 800 of FIG. 8 corresponds to the control circuit 710 of FIG. 7. As shown in FIG. 8, the control circuit 800 includes a third error amplifier EA3, a fourth error amplifier EA4, a first multiplexer MP1, a second multiplexer MP2, a first isolation circuit 811, a second isolation circuit 821, a first current comparator CPC1, a second current comparator CPC2, a fourth signal generation circuit 812, and a fifth signal generation circuit 822.

The third error amplifier EA3 generates a third error signal SEA3 based on the difference between the third output voltage VOUT3 and the third reference voltage VREF3. According to an embodiment of the invention, when the third output voltage VOUT3 decreases, the third error signal SEA3 increases. According to another embodiment of the invention, when the third output voltage VOUT3 increases, the third error signal SEA3 decreases. In other words, the third error amplifier EA3 amplifies the difference between the third output voltage VOUT3 and the third reference voltage VREF3 to generate the third error signal SEA3.

The fourth error amplifier EA4 generates a fourth error signal SEA4 based on the difference between the fourth output voltage VOUT4 and the fourth reference voltage VREF4. According to an embodiment of the invention, when the fourth output voltage VOUT4 decreases, the fourth error signal SEA4 increases. According to another embodiment of the invention, when the fourth output voltage VOUT4 increases, the fourth error signal SEA4 decreases. In other words, the fourth error amplifier EA4 amplifies the difference between the fourth output voltage VOUT4 and the fourth reference voltage VREF4 to generate the fourth error signal SEA4.

The first multiplexer MP1 selects one of the third error signal SEA3 and the fourth error signal SEA4 to output as the first selection signal SL1, based on the states of the third signal S3, the fourth signal S4, and the extended signal SE. The second multiplexer MP2 selects one of the third error signal SEA3 and the fourth error signal SEA4 to output as the second selection signal SL2, based on the states of the third signal S3, the fourth signal S4, and the extended signal SE.

According to an embodiment of the present invention, when the control circuit 710 of FIG. 7 operates in the first mode, both the first multiplexer MP1 and the second multiplexer MP2 select the third error signal SEA3 as the first selection signal SL1 and the second selection signal SL2, respectively, so that both the third secondary current IS3 and the fourth secondary current IS4 powers the third output voltage VOUT3.

According to another embodiment of the present invention, when the control circuit 710 of FIG. 7 operates in the second mode, the first multiplexer MP1 and the second multiplexer MP2 select the third error signal SEA3 and the fourth error signal SEA4 as the first selection signal SL1 and the second selection signal SL2 respectively, so that the third secondary current IS3 and the fourth secondary current IS4 power the third output voltage VOUT3 and the fourth output voltage VOUT4, respectively.

According to yet another embodiment of the present invention, when the control circuit 710 of FIG. 7 operates in the third mode, both the first multiplexer MP1 and the second multiplexer MP2 select the fourth error signal SEA4 as the first selection signal SL1 and the second selection signal SL2, so that both the third secondary current IS3 and the fourth secondary current IS4 power the fourth output voltage VOUT4.

The first isolation circuit 811 generates a first feedback signal SFB1 based on the first selection signal SL1, and the second isolation circuit 821 generates a second feedback signal SFB2 based on the second selection signal SL2. A first current comparator CPC1 compares a first primary current IP1 with a first feedback signal SFB1 to generate a first current comparison signal SCPC1.

According to an embodiment of the present invention, when the first primary current IP1 is not less than the first feedback signal SFB1, the first current comparator CPC1 disables the first current comparison signal SCPC1. According to another embodiment of the present invention, when the first primary current IP1 is less than the first feedback signal SFB1, the first current comparator CPC1 enables the first current comparison signal SCPC1.

A second current comparator CPC2 compares a second primary current IP2 with a second feedback signal SFB2 to generate a second current comparison signal SCPC2. According to an embodiment of the present invention, when the second primary current IP2 is not less than the second feedback signal SFB2, the second current comparator CPC2 disables the second current comparison signal SCPC2. According to another embodiment of the present invention, when the second primary current IP2 is less than the second feedback signal SFB2, the second current comparator CPC2 enables the second current comparison signal SCPC2.

According to some embodiments of the present invention, the control circuit 800 may further include a first current detection circuit and a second current detection circuit (not shown in FIG. 8) for detecting a first primary current IP1 and a second primary current IP2 to generate a first current detection signal (not shown in FIG. 8) and a second current detection signal (not shown in FIG. 8), respectively. A first current comparator CPC1 compares the first current detection signal and a first feedback signal SFB1 to generate a first current comparison signal SCPC1, and a second current comparator CPC2 compares the second current detection signal and the second feedback signal SFB2 to generate a second current comparison signal SCPC2. For the sake of simplicity, comparing the first primary current IP1 with the first feedback signal SFB1 and comparing the second primary current IP2 with the second feedback signal SFB2 are illustrated herein, and is not intended to be limited thereto.

The fourth signal generation circuit 812 generates a first primary control signal SP1 based on the first feedback signal SFB1 and the first current comparison signal SCPC1, thereby controlling the first primary switch SWP1. The fifth signal generation circuit 822 generates a second primary control signal SP2 based on the second feedback signal SFB2 and the second current comparison signal SCPC2, thereby controlling the second primary switch SWP2.

According to an embodiment of the present invention, when the control circuit 710 operates in the first mode, both the first multiplexer MP1 and the second multiplexer MP2 select the third error signal SEA3 as the first selection signal SL1 and the second selection signal SL2, respectively, so that the control circuit 710 controls the first primary switch SWP1 and the second primary switch SWP2 based on the third output voltage VOUT3, thereby adjusting the current values of the third secondary current IS3 and the fourth secondary current IS4.

More specifically, when the third output voltage VOUT3 is less than the third reference voltage VREF3, the control circuit 710 extends the on-time of the first primary switch SWP1 and the second primary switch SWP2 based on the difference between the third output voltage VOUT3 and the third reference voltage VREF3. When the third output voltage VOUT3 is not less than the third reference voltage VREF3, the control circuit 710 shortens the on-time of the first primary switch SWP1 and the second primary switch SWP2 based on the difference between the third output voltage VOUT3 and the third reference voltage VREF3.

According to another embodiment of the present invention, the first multiplexer MP1 and the second multiplexer MP2 respectively select the third error signal SEA3 and the fourth error signal SEA4 as the first selection signal SL1 and the second selection signal SL2, such that the control circuit 710 controls the first primary switch SWP1 based on the third output voltage VOUT3 and controls the second primary switch SWP2 based on the fourth output voltage VOUT4, thereby adjusting the current values of the third secondary current IS3 and the fourth secondary current IS4.

More specifically, when the third output voltage VOUT3 is less than the third reference voltage VREF3, the control circuit 710 extends the on-time of the first primary switch SWP1 based on the difference between the third output voltage VOUT3 and the third reference voltage VREF3. When the third output voltage VOUT3 is not less than the third reference voltage VREF3, the control circuit 710 shortens the on-time of the first primary switch SWP1 based on the difference between the third output voltage VOUT3 and the third reference voltage VREF3. When the fourth output voltage VOUT4 is less than the fourth reference voltage VREF4, the control circuit 710 extends the on-time of the second primary switch SWP2 based on the difference between the fourth output voltage VOUT4 and the fourth reference voltage VREF4. When the fourth output voltage VOUT4 is not less than the fourth reference voltage VREF4, the control circuit 710 shortens the on-time of the second primary switch SWP2 based on the difference between the fourth output voltage VOUT4 and the fourth reference voltage VREF4.

According to another embodiment of the present invention, when the control circuit 710 of FIG. 7 operates in the third mode, both the first multiplexer MP1 and the second multiplexer MP2 select the fourth error signal SEA4 as the first selection signal SL1 and the second selection signal SL2, respectively. This allows the control circuit 710 to control the first primary switch SWP1 and the second primary switch SWP2 based on the fourth output voltage VOUT4, thereby adjusting the current values of the third secondary current IS3 and the fourth secondary current IS4.

More specifically, when the fourth output voltage VOUT4 is less than the fourth reference voltage VREF4, the control circuit 710 extends the on-time of the first primary switch SWP1 and the on-time of the second primary switch SWP2 based on the difference between the fourth output voltage VOUT4 and the fourth reference voltage VREF4. When the fourth output voltage VOUT4 is not less than the fourth reference voltage VREF4, the control circuit 710 shortens the on-time of the first primary switch SWP1 and the on-time of the second primary switch SWP2 based on the difference between the fourth output voltage VOUT4 and the fourth reference voltage VREF4.

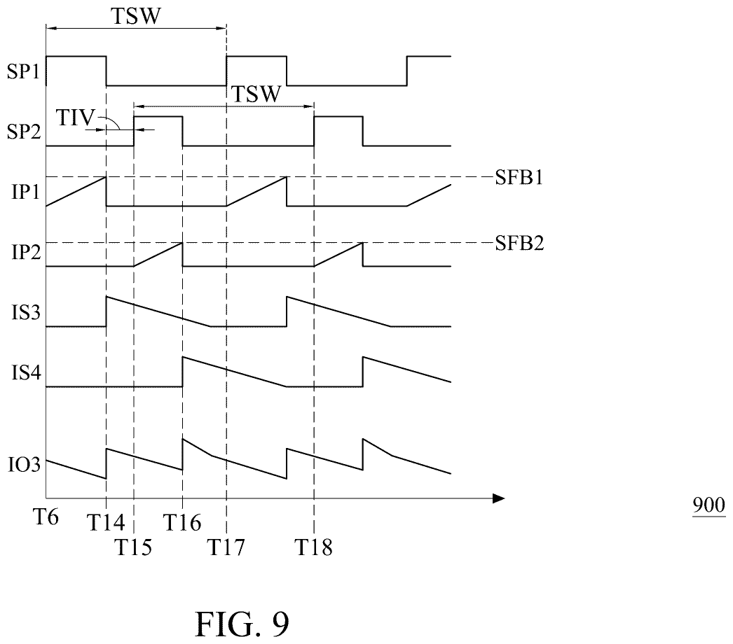

FIG. 9 shows a schematic diagram of the control circuit in accordance with another embodiment of the present invention. The following description of the waveform 900 will be provided in conjunction with the power conversion circuit 700 and the control circuit 800 for detailed explanation. In the embodiment of FIG. 9, it is illustrated that the third switch SW3 and the extension switch SWE are turned on, the fourth switch SW4 is turned off, and both the third secondary current IS3 and the fourth secondary current IS4 power the third output voltage VOUT3.

As shown in FIG. 9, at the thirteenth time point T13, the first primary control signal SP1 is enabled to turn on the first primary switch SWP1, causing the first primary current IP1 to continuously increase. When the first primary current IP1 is not less than the first feedback signal SFB1 at the fourteenth time point T14, the first primary control signal SP1 is disabled to turn off the first primary switch SWP1. According to some embodiments of the present invention, the period between the thirteenth time point T13 and the fourteenth time point T14 is the magnetization period of the first transformer TM1.

After the fourteenth time point T14, the third primary current IS3 powers the third output voltage VOUT3, making the third output current IO3 equal to the third primary current IS3. At the fifteenth time point T15, the second primary control signal SP2 is enabled to turn on the second primary switch SWP2, causing the second primary current IP2 to continuously increase.

When the second primary current IP2 is not less than the second feedback signal SFB2 at the sixteenth time point T16, the second primary control signal SP2 is disabled to turn off the second primary switch SWP2. After the sixteenth time point T16, the fourth secondary current IS4 also powers the third output voltage VOUT3, making the third output current IO3 equal to the sum of the third primary current IS3 and the fourth secondary current IS4.

According to some embodiments of the present invention, the period between the fifteenth time point T15 and the sixteenth time point T16 is the magnetization period of the second transformer TM2. According to some embodiments of the present invention, there is a phase difference between the conduction of the first primary switch SWP1 and the conduction of the second primary switch SWP2. The control circuit 710 can adjust the phase difference to stagger the magnetization periods of the first transformer TM1 and the second transformer TM2, thereby reducing the ripple of the input voltage VIN and reducing the maximum current of the input voltage VIN.

As shown in the embodiment of FIG. 9, the interval period TIV is located between the magnetization period of the first transformer TM1 and the magnetization period of the second transformer TM2. When the interval period TIV is not less than zero, the first transformer TM1 and the second transformer TM2 are magnetized in a time-division manner to reduce the maximum current of the input voltage VIN and reduce the ripple of the input voltage VIN, thereby reducing electromagnetic interference and helping to reduce the size of the transformer.

At the seventeenth time point T17, the first primary control signal SP1 is enabled again to turn on the first primary switch SWP1. At the eighteenth time point T18, the second primary control signal SP2 is enabled again to turn on the second primary switch SWP2. As shown in FIG. 9, the switching period TSW is from the thirteenth time point T13 to the seventeenth time point T17, and the switching period TSW is from the fifteenth time point T15 to the eighteenth time point T18. In other words, the control circuit 710 drives the first primary switch SWP1 and the second primary switch SWP2 at the same frequency, and turns on the first primary switch SWP1 and the second primary switch SWP2 in a time-division multiplexing manner.

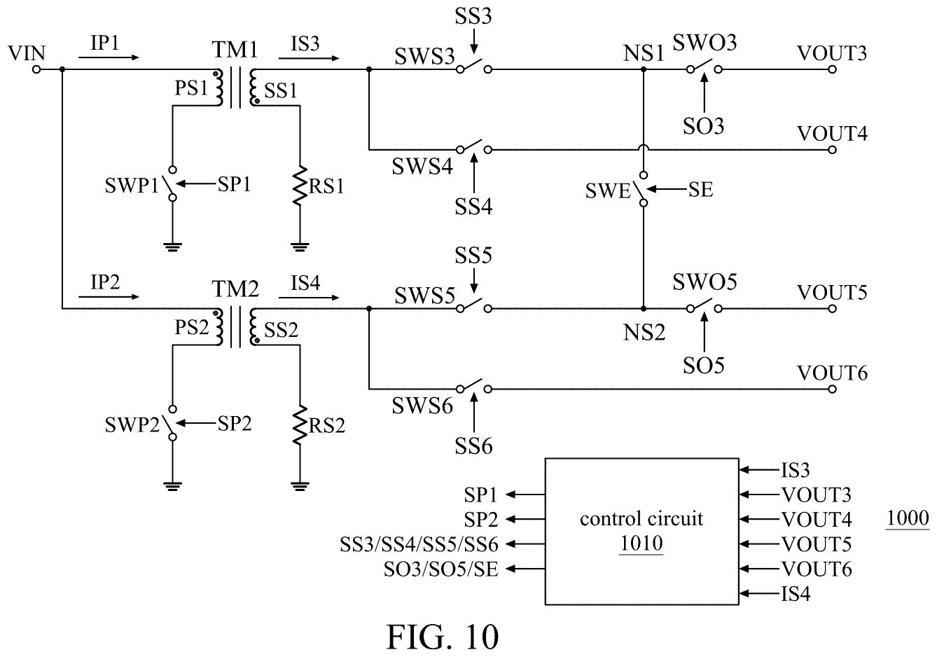

FIG. 10 shows a schematic diagram of the power conversion circuit in accordance with another embodiment of the present invention. As shown in FIG. 10, the power conversion circuit 1000 includes a first transformer TM1, a first primary switch SWP1, a first sensing resistor RS1, a second transformer TM2, a second primary switch SWP2, a second sensing resistor RS2, a third secondary switch SWS3, a third output switch SWO3, a fourth secondary switch SWS4, a fifth secondary switch SWS5, a fifth output switch SWO5, a sixth secondary switch SWS6, and an extension switch SWE. The first transformer TM1, the first primary switch SWP1, the first sensing resistor RS1, the second transformer TM2, the second primary switch SWP2, and the second sensing resistor RS2 are the same as those in FIG. 7, which are not be repeated herein.

The third-stage switch SWS3 is controlled by the third-stage signal SS3 and coupled between the first secondary coil SS1 and the first secondary node NS1. The third output switch SWO3 is controlled by the third output signal SO3 and coupled between the first secondary node NS1 and the third output voltage VOUT3. The fourth secondary switch SWS4 is controlled by the fourth secondary signal SS4 and coupled between the first secondary coil SS1 and the fourth output voltage VOUT4.

The fifth-stage switch SWS5 is controlled by the fifth secondary signal SS5 and coupled between the second secondary coil SS2 and the second secondary node NS2. The fifth output switch SWO5 is controlled by the fifth output signal SO5 and coupled between the second secondary node NS2 and the fifth output voltage VOUT5. The sixth secondary switch SWS6 is controlled by the sixth secondary signal SS6 and coupled between the second secondary coil SS2 and the sixth output voltage VOUT6. The extension switch SWE is controlled by the extension signal SE and coupled between the first secondary node NS1 and the second secondary node NS2.

According to some embodiments of the present invention, when the power conversion circuit 1000 is coupled to an external device (not shown in FIG. 10), the power conversion circuit 1000 generates a third output signal SO3, a fifth output signal SO5, and an extended signal SE based on power information provided by the external device, thereby turning on or off the third output switch SWO3, the fifth output switch SWO5, and the extended switch SWE.

According to an embodiment of the present invention, when the extension switch SWE is off and both the third output switch SWO3 and the fifth output switch SWO5 are on, as shown in FIG. 2, the control circuit 1010 powers the third output voltage VOUT3 and the fourth output voltage VOUT4 using the third secondary current IS3, and powers the fifth output voltage VOUT5 and the sixth output voltage VOUT6 using the fourth secondary current IS4, based on the third output voltage VOUT3, the fourth output voltage VOUT4, the fifth output voltage VOUT5, and the sixth output voltage VOUT6 (or, as shown in FIG. 3, based on the third output voltage VOUT3, the fourth output voltage VOUT4, the third secondary current IS3, the fifth output voltage VOUT5, the sixth output voltage VOUT6, and the fourth secondary current IS4).

According to another embodiment of the present invention, when the third output switch SWO3 and the extension switch SWE are both turned on and the fifth output switch SWO5 is turned off, the control circuit 1010 controls the third secondary switch SWS3, the fourth secondary switch SWS4, and the first primary switch SWP1 to supply power to the third output voltage VOUT3 and the fourth output voltage VOUT4 using the third secondary current IS3, and controls the fifth secondary switch SWS5, the sixth secondary switch SWS6, and the second primary switch SWP2 to supply power to the third output voltage VOUT3 and the sixth output voltage VOUT6 using the fourth secondary current IS4.

According to another embodiment of the present invention, when the fifth output switch SWO5 and the extension switch SWE are both turned on and the third output switch SWO3 is turned off, the control circuit 1010 controls the third secondary switch SWS3, the fourth secondary switch SWS4, and the first primary switch SWP1 to supply power to the fourth output voltage VOUT4 and the fifth output voltage VOUT5 using the third secondary current IS3, and controls the fifth secondary switch SWS5, the sixth secondary switch SWS6, and the second primary switch SWP2 to supply power to the fifth output voltage VOUT5 and the sixth output voltage VOUT6 using the fourth secondary current IS4.

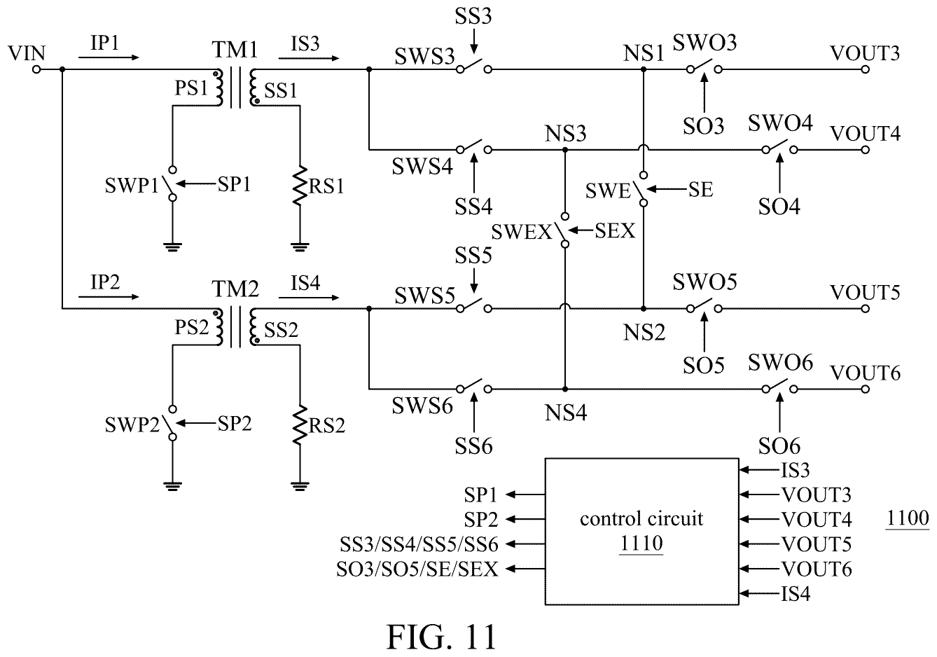

FIG. 11 shows a schematic diagram of the power conversion circuit in accordance with another embodiment of the present invention. Compared with the power conversion circuit 1000 of FIG. 10, the power conversion circuit 1100 further includes an additional extension switch SWEX, and the control circuit 1010 of FIG. 10 is replaced by the control circuit 1110.

As shown in FIG. 11, the additional extension switch SWEX is coupled between the third secondary node NS3 and the fourth secondary node NS4, and is controlled by the additional extension signal SEX. According to some embodiments of the present invention, when the power conversion circuit 1100 is coupled to an external device (not shown in FIG. 11), the control circuit 1110 generates a third output signal SO3, a fourth output signal SO4, an extension signal SE, an additional extension signal SEX, a fifth output signal SO5, and a sixth output signal SO6 based on power information provided by the external device, thereby controlling the third output switch SWO3, the fourth output switch SWO4, the extension switch SWE, the additional extension switch SWEX, the fifth output switch SWO5, and the sixth output switch SWO6.

According to some embodiments of the present invention, by controlling the third output switch SWO3, the fourth output switch SWO4, the extension switch SWE, the additional extension switch SWEX, the fifth output switch SWO5, and the sixth output switch SWO6, the energy of the first transformer TM1 and the second transformer TM2 can be used to supply power to each of the third output voltage VOUT3, the fourth output voltage VOUT4, the fifth output voltage VOUT5, and the sixth output voltage VOUT6. Alternatively, the energy of the first transformer TM1 and the second transformer TM2 can be used to centrally supply power to at least one of the third output voltage VOUT3, the fourth output voltage VOUT4, the fifth output voltage VOUT5, and the sixth output voltage VOUT6, thereby reducing the maximum current of the input voltage VIN and reducing the size of the required transformer.

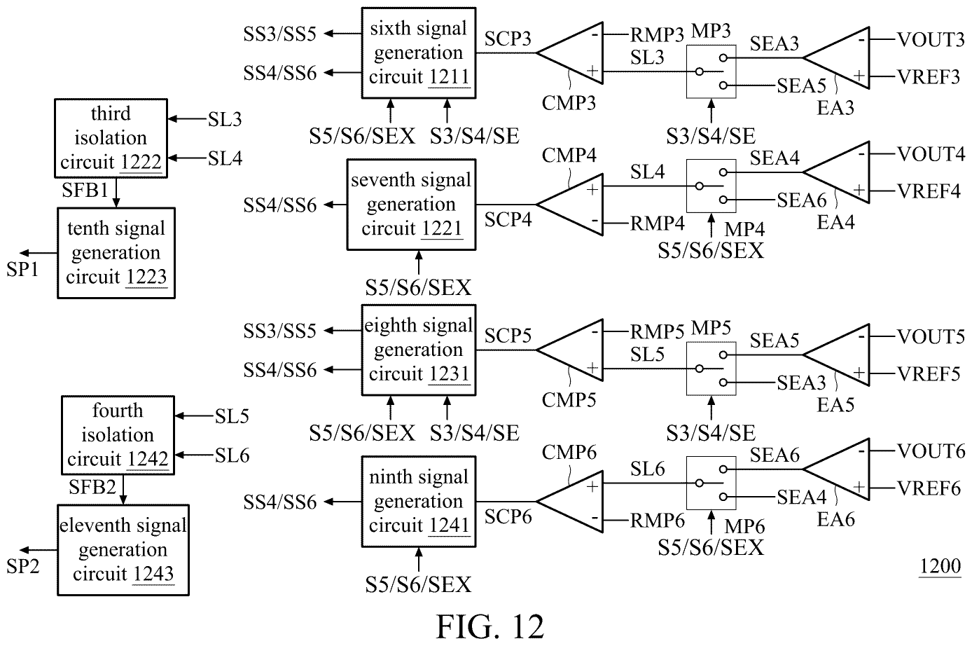

FIG. 12 shows a schematic diagram of the control circuit in accordance with yet another embodiment of the present invention. According to some embodiments of the present invention, the control circuit 1200 corresponds to control circuit 1110 in FIG. 11. As shown in FIG. 12, the control circuit 1200 includes a third error amplifier EA3, a fourth error amplifier EA4, a fifth error amplifier EA5, and a sixth error amplifier EA6.

The third error amplifier EA3 generates a third error signal SEA3 based on the difference between the third output voltage VOUT3 and the third reference voltage VREF3. The fourth error amplifier EA4 generates a fourth error signal SEA4 based on the difference between the fourth output voltage VOUT4 and the fourth reference voltage VREF4. The fifth error amplifier EA5 generates a fifth error signal SEA5 based on the difference between the fifth output voltage VOUT5 and the fifth reference voltage VREF5. The sixth error amplifier EA6 generates a sixth error signal SEA6 based on the difference between the sixth output voltage VOUT6 and the sixth reference voltage VREF6.

As shown in FIG. 12, the control circuit 1200 further includes a third multiplexer MP3, a fourth multiplexer MP4, a fifth multiplexer MP5, and a sixth multiplexer MP6. The third multiplexer MP3 selects one of the third error signal SEA3 and the fifth error signal SEA5 based on the states of the third signal S3, the fourth signal S4, and the extended signal SE to output as the third selection signal SL3. The fourth multiplexer MP4 selects one of the fourth error signal SEA4 and the sixth error signal SEA6 based on the states of the fifth signal S5, the sixth signal S6, and the additional extended signal SEX to output as the fourth selection signal SL4. The fifth multiplexer MP5 selects one of the fifth error signal SEA5 and the third error signal SEA3 based on the states of the third signal S3, the fourth signal S4, and the extended signal SE to output as the fifth selection signal SL5. The sixth multiplexer MP6 selects one of the sixth error signal SEA6 and the fourth error signal SEA4 based on the states of the fifth signal S5, the sixth signal S6, and the additional extended signal SEX to output as the sixth selection signal SL6.

The control circuit 1200 further includes a third comparator CMP3, a fourth comparator CMP4, a fifth comparator CMP5, and a sixth comparator CMP6. The third comparator CMP3 compares the third selection signal SL3 and the third sawtooth wave RMP3 to generate the third comparison signal SCP3. The fourth comparator CMP4 compares the fourth selection signal SL4 and the fourth sawtooth wave RMP4 to generate the fourth comparison signal SCP4. The fifth comparator CMP5 compares the fifth selection signal SL5 and the fifth sawtooth wave RMP5 to generate the fifth comparison signal SCP5. The sixth comparator CMP6 compares the sixth selection signal SL6 and the sixth sawtooth wave RMP6 to generate the sixth comparison signal SCP6.

The control circuit 1200 further includes a sixth signal generation circuit 1211, a seventh signal generation circuit 1221, an eighth signal generation circuit 1231, and a ninth signal generation circuit 1241. When the third sawtooth wave RMP3 is less than the third selection signal SL3, the sixth signal generation circuit 1211 enables the third secondary signal SS3 or the fifth secondary signal SS5 based on the third signal S3, the fourth signal S4, and the extended signal SE. When the third sawtooth wave RMP3 is not less than the third selection signal SL3, the sixth signal generation circuit 1211 disables the third secondary signal SS3 or the fifth secondary signal SS5 based on the third signal S3, the fourth signal S4, and the extended signal SE, and enables the fourth secondary signal SS4 or the sixth secondary signal SS6 based on the fifth signal S5, the sixth signal S6, and the additional extended signal SEX. When the fourth sawtooth wave RMP4 is not less than the fourth selection signal SL4, the seventh signal generation circuit 1221 disables the fourth secondary signal SS4 or the sixth secondary signal SS6 based on the fifth signal S5, the sixth signal S6, and the additional extended signal SEX.

When the fifth sawtooth wave RMP5 is less than the fifth selection signal SL5, the eighth signal generation circuit 1231 enables the third secondary signal SS3 or the fifth secondary signal SS5 based on the third signal S3, the fourth signal S4, and the extended signal SE. When the fifth sawtooth wave RMP5 is not less than the fifth selection signal SL5, the eighth signal generation circuit 1231 disables the third secondary signal SS3 or the fifth secondary signal SS5 based on the third signal S3, the fourth signal S4, and the extended signal SE, and simultaneously enables the fourth secondary signal SS4 or the sixth secondary signal SS6 based on the fifth signal S5, the sixth signal S6, and the additional extended signal SEX. When the sixth sawtooth wave RMP6 is not less than the sixth selection signal SL6, the ninth signal generation circuit 1241 disables the fourth secondary signal SS4 or the sixth secondary signal SS6 based on the fifth signal S5, the sixth signal S6, and the additional extended signal SEX.

As shown in FIG. 12, the control circuit 1200 further includes a third isolation circuit 1222, a tenth signal generation circuit 1223, a fourth isolation circuit 1242, and an eleventh signal generation circuit 1243. The third isolation circuit 1222 generates a first feedback signal SFB1 based on the third selection signal SL3 and the fourth selection signal SL4. The tenth signal generation circuit 1223 generates a first primary control signal SP1 based on the first feedback signal SFB1, thereby controlling the first primary switch SWP1.

The fourth isolation circuit 1242 generates a second feedback signal SFB2 based on the fifth selection signal SL5 and the sixth selection signal SL6. The eleventh signal generation circuit 1243 generates a second primary control signal SP2 based on the second feedback signal SFB2, thereby controlling the second primary switch SWP2.

According to some embodiments of the present invention, the control circuit 1200 generates the first primary control signal SP1 and the second primary control signal SP2 based on the third output voltage VOUT3, the fourth output voltage VOUT4, the fifth output voltage VOUT5, and the sixth output voltage VOUT6, thereby controlling the on-time of the first primary switch SWP1 and the on-time of the second primary switch SWP2 to adjust the third secondary current IS3 and the fourth secondary current IS4.

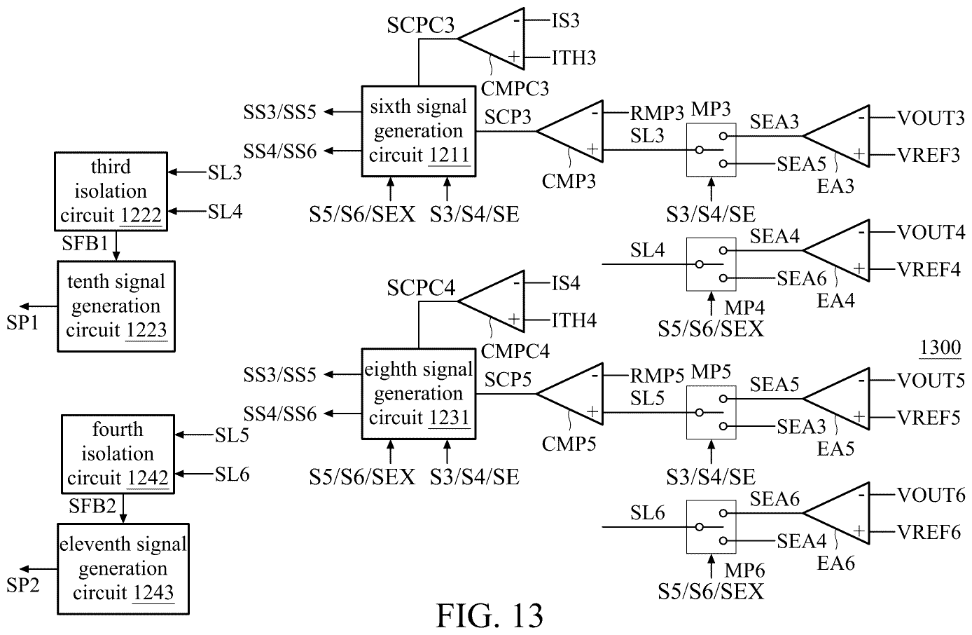

FIG. 13 shows a schematic diagram of the control circuit in accordance with yet another embodiment of the present invention. According to some embodiments of the present invention, the control circuit 1300 corresponds to the control circuit 1110 in FIG. 11. Comparing control circuit 1300 with control circuit 1200 in FIG. 12, the fourth comparator CMP4 and the seventh signal generation circuit 1221 in FIG. 12 are replaced by a third current comparator CMPC3, and the sixth comparator CMP6 and the ninth signal generation circuit 1241 in FIG. 12 are replaced by a fourth current comparator CMPC4.

As shown in FIG. 13, the third current comparator CMPC3 compares the third secondary current IS3 with the third current threshold ITH3 to generate a third current comparison signal SCPC3. According to an embodiment of the present invention, when the third secondary current IS3 is less than the third current threshold ITH3, the third current comparator CMPC3 enables the third current comparison signal SCPC3. According to another embodiment of the present invention, when the third secondary current IS3 is not less than the third current threshold ITH3, the third current comparator CMPC3 disables the third current comparison signal SCPC3.

According to some embodiments of the present invention, after the sixth signal generation circuit 1211 enables the fourth secondary switch SWS4 or the sixth secondary switch SWS6 and the third secondary current IS3 is less than the third current threshold ITH3, the sixth signal generation circuit 1211 disables the fourth secondary switch SWS4 or the sixth secondary switch SWS6 based on the fifth signal S5, the sixth signal S6, the additional extended signal SEX, and the enabled third current comparison signal SCPC3, where the third current threshold ITH3 is close to zero.

The fourth current comparator CMPC4 compares the fourth secondary current IS4 with the fourth current threshold ITH4 to generate the fourth current comparison signal SCPC4. According to an embodiment of the present invention, when the fourth secondary current IS4 is less than the fourth current threshold ITH4, the fourth current comparator CMPC4 enables the fourth current comparison signal SCPC4. According to another embodiment of the present invention, when the fourth secondary current IS4 is not less than the fourth current threshold ITH4, the fourth current comparator CMPC4 disables the fourth current comparison signal SCPC4.

According to some embodiments of the present invention, after the eighth signal generation circuit 1231 enables the fourth secondary switch SWS4 or the sixth secondary switch SWS6 and the fourth secondary current IS4 is less than the fourth current threshold ITH4, the eighth signal generation circuit 1231 disables the fourth secondary switch SWS4 or the sixth secondary switch SWS6 based on the fifth signal S5, the sixth signal S6, the additional extended signal SEX, and the enabled fourth current comparison signal SCPC4, where the fourth current threshold ITH4 is close to zero.

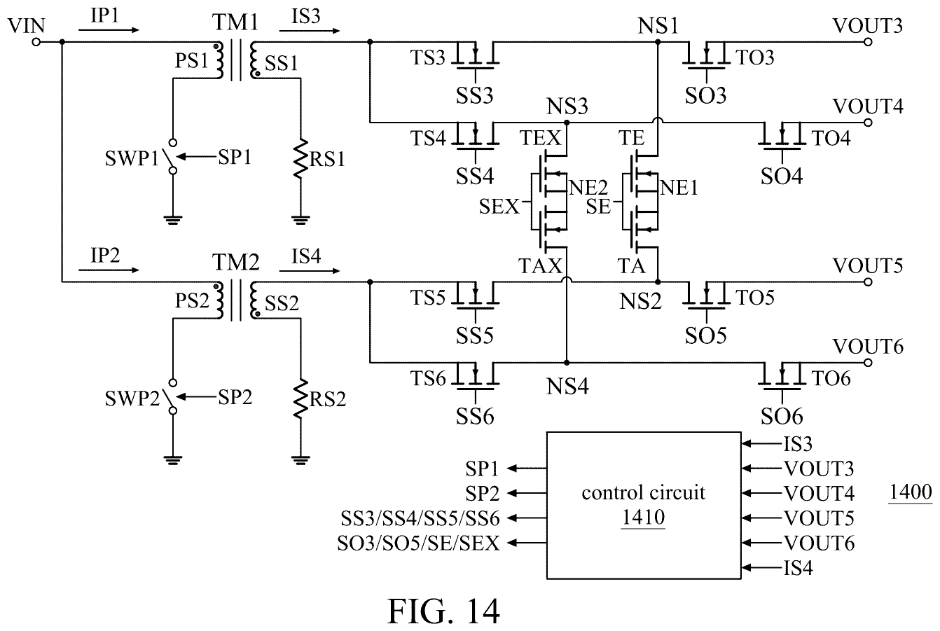

FIG. 14 shows a schematic diagram of the power conversion circuit in accordance with yet another embodiment of the present invention. Compared to the power conversion circuit 1100 in FIG. 11, the third secondary switch SWS3, the fourth secondary switch SWS4, the fifth secondary switch SWS5, and the sixth secondary switch SWS6 are replaced by the third secondary transistor TS3, the fourth secondary transistor TS4, the fifth secondary transistor TS5, and the sixth secondary transistor TS6, respectively. The third output switch SWO3, the fourth output switch SWO4, the fifth output switch SWO5, and the sixth output switch SWO6 are replaced by the third output transistor TO3, the fourth output transistor TO4, the fifth output transistor TO5, and the sixth output transistor TO6, respectively.

According to some embodiments of the present invention, the connection relationships between the third secondary transistor TS3 and the third output transistor TO3, the fourth secondary transistor TS4 and the fourth output transistor TO4, the fifth secondary transistor TS5 and the fifth output transistor TO5, and the sixth secondary transistor TS6 and the sixth output transistor TO6 are as shown in FIG. 5, and will not be repeated herein.

Furthermore, the extension switch SWE in FIG. 11 is replaced by an extension transistor TE and an auxiliary transistor TA connected in series, where the base terminals of both the extension transistor TE and the auxiliary transistor TA are coupled to the first extension node NE1. The additional extension switch SWEX in FIG. 11 is replaced by an additional extension transistor TEX and an additional auxiliary transistor TAX connected in series, where the base terminals of the additional extension transistor TEX and the additional auxiliary transistor TAX are coupled to the second extension node NE2.

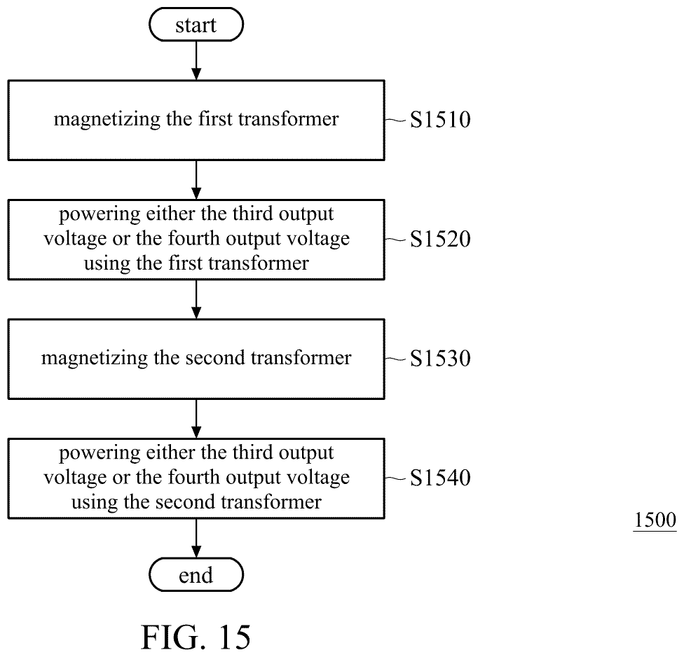

FIG. 15 shows a flowchart of the control method in accordance with an embodiment of the present invention. The following description of the control method 1500 will be provided in conjunction with the power conversion circuit 700 in FIG. 7 and the waveform diagram 900 in FIG. 9 for detailed explanation.

First, the first transformer TM1 is magnetized using the input voltage VIN during the first magnetization period (step S1510). According to an embodiment of the present invention, the first magnetization period is between the thirteenth time point T13 and the fourteenth time point T14 in FIG. 9. When the first transformer TM1 is demagnetized, the third secondary current IS3 generated by the first transformer TM1 powers one of the third output voltage VOUT3 and the fourth output voltage VOUT4 (step S1520). According to an embodiment of the present invention, the first transformer TM1 is demagnetized between the fourteenth time point T14 and the seventeenth time point T17 in FIG. 9.

After the above-mentioned first magnetization period, the second transformer TM2 is magnetized using the input voltage VIN during the second magnetization period (step S1530). According to an embodiment of the present invention, the second magnetization period is between the fifteenth time point T15 and the sixteenth time point T16 in FIG. 9. According to some embodiments of the present invention, there is an interval period TIV between the first magnetization period and the second magnetization period, where the interval period TIV is not less than zero. In other words, the first magnetization period and the second magnetization period do not overlap.

When the second transformer TM2 is demagnetized, the fourth secondary current IS4 generated by the second transformer TM2 powers one of the third output voltage VOUT3 and the fourth output voltage VOUT4 (step S1540). According to an embodiment of the present invention, the second transformer TM2 is demagnetized between the sixteenth time point T16 and the eighteenth time point T18 in FIG. 9.

According to an embodiment of the present invention, when the third switch SW3 and the extension switch SWE in FIG. 7 are both on and the fourth switch SW4 is off, both the third secondary current IS3 and the fourth secondary current IS4 power the third output voltage VOUT3. According to another embodiment of the present invention, when both the third switch SW3 and the fourth switch SW4 in FIG. 7 are on and the extension switch SWE is off, the third secondary current IS3 and the fourth secondary current IS4 power the third output voltage VOUT3 and the fourth output voltage VOUT4, respectively.

According to another embodiment of the present invention, when the fourth switch SW4 and the extension switch SWE are both on and the third switch SW3 is off, both the third secondary current IS3 and the fourth secondary current IS4 power the fourth output voltage VOUT4. In other words, in steps S1520 and S1540, one of the third output voltage VOUT3 and the fourth output voltage VOUT4 is powered based on the states of the third switch SW3, the fourth switch SW4, and the extension switch SWE.

According to some embodiments of the present invention, it is further determined that the power conversion circuit 700 operates in one of the first mode, the second mode, and the third mode. When operating in the first mode, in step S1520, the third output voltage VOUT3 is powered using the third secondary current IS3 generated by the first transformer TM1, and in step S1540, the third output voltage VOUT3 is powered using the fourth secondary current IS4 generated by the second transformer TM2.

When operating in the second mode, in step S1520, the third secondary current IS3 powers the third output voltage VOUT3, and in step S1540, the fourth secondary current IS4 powers the fourth output voltage VOUT4. When operating in the third mode, in step S1520, the third secondary current IS3 powers the fourth output voltage VOUT4, and in step S1540, the fourth secondary current IS4 powers the fourth output voltage VOUT4.

This invention proposes a power conversion circuit for generating multiple output voltages and a control method thereof, which can power multiple output voltages using a single transformer or multiple transformers. When multiple transformers power multiple output voltages, multiple transformers can both power a single output voltage, allowing the power of different transformers to be shared, thereby reducing the required size of the transformers and lowering the maximum current of the input voltage. Furthermore, the multiple transformers in the power conversion circuit proposed in this invention can also individually power different output voltages, enabling the power conversion circuit to generate different output voltages without the assistance of other voltage regulators. In addition, staggering the magnetization periods of multiple transformers can effectively avoid the problem of beat frequency and suppress electromagnetic interference.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit, comprising:
a first transformer, comprising a first primary coil and a first secondary coil, wherein the first primary coil receives an input voltage and the first secondary coil generates a first secondary current;
a first primary switch, coupling the first primary coil to a ground based on a first primary control signal;
a second transformer, comprising a second primary coil and a second secondary coil, wherein the second secondary coil receives the input voltage, and the second secondary coil generates a second secondary current;
a second primary switch, coupling the second primary coil to the ground based on a second primary control signal;
a first switch, coupled between the first primary coil and a first output voltage;
a second switch, coupled between the second secondary coil and a second output voltage;
an extension switch, coupled between the first switch and the second switch; and
a control circuit, driving the first primary switch and the second primary switch to respectively magnetize the first transformer and the second transformer and operating in a first mode and a second mode;
wherein when the control circuit operates in the first mode, the first switch and the extension switch are both turned on and the second switch is turned off, so that the first secondary current and the second secondary current both power the first output voltage;
wherein when the control circuit operates in the second mode, the first switch and the second switch are both turned on and the extension switch is turned off, so that the first secondary current and the second secondary current power the first output voltage and the second output voltage respectively;
wherein the control circuit turns on the first primary switch and the second primary switch in a time-division manner at a switching frequency.

2. The power conversion circuit as claimed in claim 1, wherein the switching frequency is adjustable;
wherein there is a phase difference between the first primary switch turning on and the second primary switch turning on;
wherein the control circuit adjusts the phase difference, causing an on-time of the first primary switch and the second primary switch to be staggered.

3. The power conversion circuit as claimed in claim 1, further comprising:
a first synchronous rectification unit, coupled between the first secondary coil and the first switch, causing the first secondary current to flow unidirectionally to the first switch and the extension switch; and
a second synchronous rectification unit, coupled between the second secondary coil and the second switch, causing the second secondary current to flow unidirectionally to the second switch and the extension switch.

4. The power conversion circuit as claimed in claim 1, wherein when the control circuit operates in the first mode, the first switch and the extension switch are turned on and the second switch is turned off, causing both the first secondary current and the second secondary current to power the first output voltage.

5. The power conversion circuit as claimed in claim 1, wherein when the control circuit operates in the second mode, the first switch and the second switch are turned on and the extension switch is turned off, causing the first secondary current to independently power the first output voltage and the second secondary current to independently power the second output voltage.

6. The power conversion circuit as claimed in claim 1, wherein when the control circuit operates in a third mode, the second switch and the extension switch are turned on and the first switch is turned off, causing both the first secondary current and the second secondary current to power the second output voltage.

7. The power conversion circuit as claimed in claim 6, wherein the control circuit further comprises:
a first error amplifier, comparing the first output voltage to a first reference voltage to generate a first error signal;
a second error amplifier, comparing the second output voltage to a second reference voltage to generate a second error signal;
a first multiplexer, outputting the first error signal or the second error signal as a first selection signal based on states of the first switch, the second switch, and the extension switch;
a second multiplexer, outputting the first error signal or the second error signal as a second selection signal based on the states of the first switch, the second switch, and the extension switch;
a first isolation circuit, generating a first feedback signal based on the first selection signal;
a second isolation circuit, generating a second feedback signal based on the second selection signal;
a first signal generation circuit, driving the first primary switch based on the first feedback signal; and
a second signal generation circuit, driving the second primary switch based on the second feedback signal.

8. The power conversion circuit as claimed in claim 7, wherein when the control circuit operates in the first mode, the first signal generation circuit and the second signal generation circuit extend an on-time of the first primary switch and an on-time of the second primary switch based on the first output voltage that is lower than the first reference voltage;
wherein when the control circuit operates in the first mode, the first signal generation circuit and the second signal generation circuit shorten the on-time of the first primary switch and the on-time of the second primary switch based on the first output voltage that is lower than the first reference voltage.

9. The power conversion circuit as claimed in claim 7, wherein when the control circuit operates in the second mode, the first signal generation circuit turns on the first primary switch based on the first output voltage that is lower than the first reference voltage, and the second signal generation circuit turns on the second primary switch based on the second output voltage that is lower than the second reference voltage;
wherein when the control circuit operates in the second mode, the first signal generation circuit shortens an on-time of the first primary switch based on the first output voltage not lower than the first reference voltage, and the second signal generation circuit shortens an on-time of the second primary switch based on the second output voltage not lower than the second reference voltage;
wherein when the control circuit operates in the second mode, the first signal generation circuit extends the on-time of the first primary switch based on the first output voltage that is lower than the first reference voltage, and the second signal generation circuit extends the on-time of the second primary switch based on the second output voltage that is lower than the second reference voltage.

10. The power conversion circuit as claimed in claim 7, wherein when the control circuit operates in the third mode, the first signal generation circuit and the second signal generation circuit extend an on-time of the first primary switch and an on-time of the second primary switch based on the second output voltage that is lower than the second reference voltage;
wherein when the control circuit operates in the third mode, the first signal generation circuit and the second signal generation circuit shorten the on-time of the first primary switch and the on-time of the second primary switch based on the second output voltage that is not lower than the second reference voltage.

11. The power conversion circuit as claimed in claim 1, further comprising:
a third switch, coupled between the first secondary coil and a third output voltage;
wherein when the third switch is turned on, the first secondary current powers the third output voltage.

12. The power conversion circuit as claimed in claim 11, further comprising:
a fourth switch, coupled between the second secondary coil and a fourth output voltage;
wherein when the fourth switch is turned on, the second secondary current powers the fourth output voltage.

13. The power conversion circuit as claimed in claim 12, further comprising:
an additional extension switch, coupled between the third switch and the fourth switch.

14. A control method for controlling a power conversion circuit to convert an input voltage into a first output voltage and a second output voltage, wherein the power conversion circuit comprises a first transformer and a second transformer, wherein the control method comprises:
magnetizing the first transformer using the input voltage during a first magnetization period;
when the first transformer is demagnetized, powering either the first output voltage or the second output voltage using a first secondary current generated by a secondary coil of the first transformer;
magnetizing the second transformer using the input voltage during a second magnetization period; and
when the second transformer is demagnetized, powering either the first output voltage or the second output voltage using a second secondary current generated by a secondary coil of the second transformer.

15. The control method as claimed in claim 14, further comprising:
determining that the power conversion circuit operates in one of a first mode, a second mode, and a third mode;
when operating in the first mode, powering the first output voltage using the first secondary current and the second secondary current;
when operating in the second mode, powering the first output voltage using the first secondary current and powering the second output voltage using the second secondary current using the second secondary current; and
when operating in the third mode, powering the second output voltage using the first secondary current and the second secondary current.

16. The control method as claimed in claim 15, further comprising:
when operating in the first mode, determining a relationship between the first output voltage and a first reference voltage;
when the first output voltage is lower than the first reference voltage, extending the first magnetization period and the second magnetization period based on a difference between the first output voltage and the first reference voltage; and
when the first output voltage is not lower than the first reference voltage, shortening the first magnetization period and the second magnetization period based on the difference between the first output voltage and the first reference voltage.

17. The control method as claimed in claim 15, further comprising:
when operating in the second mode, determining a relationship between the first output voltage and a first reference voltage and a relationship between the second output voltage and a second reference voltage;
when the first output voltage is lower than the first reference voltage, extending the first magnetization period based on a difference between the first output voltage and the first reference voltage;
when the first output voltage is not lower than the first reference voltage, shortening the first magnetization period based on the first output voltage and the first reference voltage;
when the second output voltage is lower than the second reference voltage, extending the second magnetization period based on a difference between the second output voltage and the second reference voltage; and
when the second output voltage is not lower than the second reference voltage, shortening the second magnetization period based on the difference between the second output voltage and the second reference voltage.

18. The control method as claimed in claim 15, further comprising:
when operating in the third mode, determining a relationship between the second output voltage and a second reference voltage;
when the second output voltage is lower than the second reference voltage, extending the first magnetization period and the second magnetization period based on a difference between the second output voltage and the second reference voltage; and
when the second output voltage is not lower than the second reference voltage, shortening the first magnetization period and the second magnetization period based on the difference between the second output voltage and the second reference voltage.

19. The control method as claimed in claim 14, wherein there is an interval period between the first magnetization period and the second magnetization period;
wherein the interval period is not less than zero.

20. The control method as claimed in claim 14, further comprising:
when a first primary current flowing through a first primary coil of the first transformer is not less than a first threshold, ending the first magnetization period; and
when a second primary current flowing through a second primary coil of the second transformer is not less than a second threshold, ending the second magnetization period.
